(19) United States
(12) Patent Application Publication
(10) Pub. No.: US 2006/0213680 A1
(43) Pub. Date: Sep. 28, 2006

(54) COUPLED BUILDING WIRE

(76) Inventors: JOHN R. CARLSON, Newman, GA (US); C. David Mercier, Carrollton, GA (US); Mark D. Dixon, Carrollton, GA (US); Randy D. Kummer, Villa Rica, GA (US)

Correspondence Address: SMITH, GAMBRELL & RUSSELL, SUITE 3100, PROMENADE II, 1230 PEACHTREE STREET, N.E., ATLANTA, GA, 30307-3592, US

(21) Appl. No.: 11/423,193

(22) Filed: Jun. 9, 2006

Related U.S. Application Data
(63) Continuation-in-part of application No. 10/955,436, filed on Sep. 30, 2004.

(51) Int. Cl. H01B 7/00

(52) U.S. Cl. 174/115

(57) ABSTRACT

The coupled building wire of the present invention comprises a first length of non-metallic cable having a top surface and a bottom surface and a second length non-metallic cable having a top surface and a bottom surface, wherein the bottom surface of the first length of non-metallic cable is coupled to the top surface of the second length of non-metallic cable. The first length of non-metallic cable comprises at least one circuit conductor having a first gauge. The second length of non-metallic cable comprises at least one circuit conductor having a second gauge. The first gauge of the at least one circuit conductor of the first length of non-metallic cable may be substantially equal or unequal to the second gauge of the at least one circuit conductor of the second length of non-metallic cable.

### RELATED APPLICATIONS

This application is a continuation-in-part of U.S. patent application Ser. No. 10/955,436, filed Sep. 30, 2004, and claims the benefit of priority of U.S. provisional application Ser. No. 60/508,148, filed Oct. 1, 2003, and U.S. provisional application Ser. No. 60/517,851, filed Nov. 6, 2003, which are relied on and incorporated herein by reference.

### FIELD OF THE INVENTION

The present invention relates generally to electrical wire and cable. More specifically, the present invention relates to coupled building wire comprising more than one length of non-metallic sheathed cable, wherein the lengths of cable are coupled so that an electrician can pull more than one length of cable into a structure at a time.

### BACKGROUND OF THE INVENTION

Non-metallic (“NM”) sheathed cable is suitable for use in concealed or exposed, dry, protected areas (e.g., inside stud walls and on the sides of joists) and is commonly used to provide electrical power throughout homes built in the United States. NM cable is installed during the construction phase of a building, home, or other structure by pulling a length of cable from a coil into the structure and through openings or bores formed in the structure's internal framing elements, cutting the cable at its desired length, and connecting the cable to various components such as outlet boxes, junction boxes, switches, and fixtures.

Conventional NM cable is sold as a single unit, i.e., each coil contains one length of cable (a “circuit”) that has a uniform gauge or size. Consequently, when an electrician needs to install more than one circuit at once, he or she must pull each circuit from a separate coil. The use of multiple coils is a significant burden that requires extra set up time and often results in the undesirable entanglement of the two lengths of cable.

Because electricians frequently use more than one gauge of cable in the construction of a home, the burden of using multiple coils is commonly experienced. For example, in a typical home, each room has lighting elements that require one gauge of NM cable and electrical outlets that require a different gauge of NM cable. In particular, a 15-amp circuit used for lighting will employ a 14 American Wire Gauge (“AWG”) NM cable, but a 20-amp circuit used for electrical outlets will employ a 12 AWG NM cable. Thus, during construction, a length of 14 AWG NM cable and a length of 12 AWG NM cable will need to be pulled into each room, which conventionally requires the set up and use of more than one coil. As another example, a single room may need more than one dedicated 15-amp circuit, thereby requiring that more than one length of 14 AWG NM cable be pulled into the room. Here, as in the previous example, it would be preferable to be able to pull all of the necessary lengths of wire from a single coil to reduce the time needed to set up multiple coils and to eliminate the risk of entanglement.

Accordingly, a need therefore exists for a NM cable construction comprising more than one length of cable, wherein the lengths of cable are coupled so that an electrician can pull more than one length of cable into a structure at a time.

### SUMMARY OF THE INVENTION

The present invention answers this need by providing a coupled building wire wherein more than one length of NM cable, having the same or different gauges, are coupled together so that an electrician may pull more than one length of cable into a structure from a single coil.

More specifically, the present invention relates to a coupled building wire comprising a first length of NM cable having a top surface and a bottom surface, and a second length NM cable having a top surface and a bottom surface, wherein the bottom surface of the first length of NM cable is coupled to the top surface of the second length of NM cable.

It is thus an advantage of the present invention to provide a coupled building wire that permits more than one length of cable to be dispensed simultaneously without entanglement.

It is another advantage of the present invention to a coupled building wire that permits an electrician to draw lengths of cable having different gauges simultaneously from a single coil and without entanglement.

These and further advantages of the present invention will become apparent after a review of the following detailed description of the disclosed embodiments.

### BRIEF DESCRIPTION OF THE DRAWINGS

FIG. 1 is a cross sectional view of a length of non-metallic sheathed cable which may be used to construct the present invention.

FIG. 2 is a cross sectional view of a coupled building wire according to a first embodiment of the present invention.

FIG. 3 is a cross sectional view of a coupled building wire according to a second embodiment of the present invention.

FIG. 4 is a cross sectional view of a coupled building wire according to a third embodiment of the present invention.

FIG. 5 is a cross sectional view of a coupled building wire according to a fourth embodiment of the present invention.

### DETAILED DESCRIPTION OF THE INVENTION

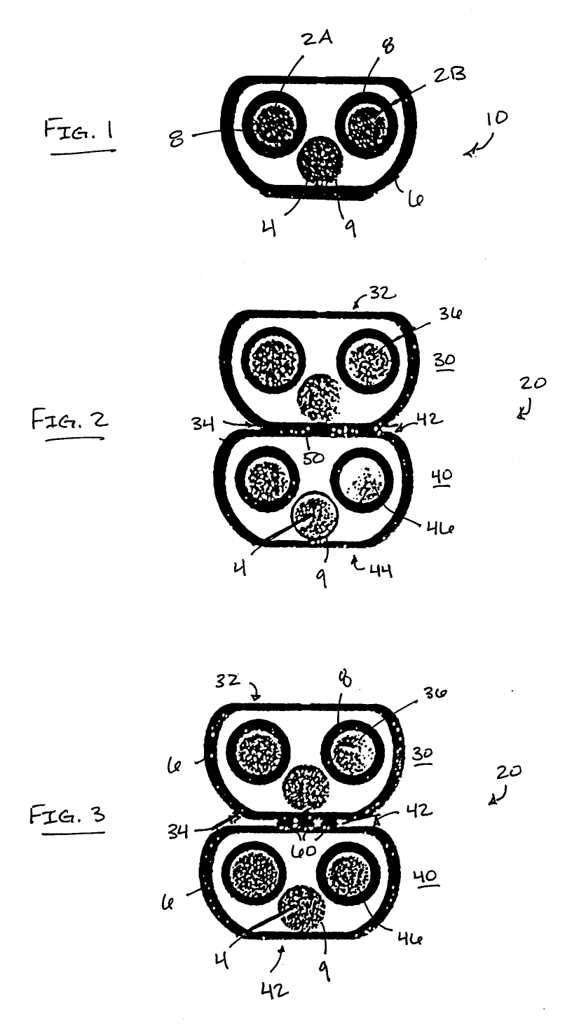

With reference to FIG. 1, a length of non-metallic (“NM”) sheathed cable 10 comprises two circuit conductors 2A and 2B, a grounding conductor 4, and an outer sheath 6. The two circuit conductors 2A and 2B and the grounding conductor 4 are generally constructed of copper or aluminum alloys and may be of sizes 14 American Wire Gauge (“AWG”) to 2 AWG. The outer sheath 6 is conventionally constructed of polyvinyl chloride (“PVC”). Each circuit conductor 2A and 2B is wrapped in insulation 8 that is conventionally constructed of PVC. The grounding conductor 4 may be wrapped in paper 9 to prevent contact with the outer sheath 6 and the insulation 8.

With reference to FIG. 2, the present invention provides a coupled building wire 20 comprising a first length of NM cable 30 having a top surface 32 and a bottom surface 34, a second length NM cable 40 having a top surface 42 and a bottom surface 44, wherein the bottom surface 34 of the first length of NM cable 30 is coupled to the top surface 42 of the second length of NM cable 40. The first length of NM cable 30 comprises at least one circuit conductor 36 having a first gauge and the second length of NM cable 40 comprises at least one circuit conductor 46 having a second gauge.

In the depicted embodiment, the first gauge of the at least one circuit conductor 36 of the first length of NM cable 30 is substantially equal to the second gauge of the at least one circuit conductor 46 of the second length of NM cable 40. In other embodiments, the first gauge of the at least one circuit conductor 36 of the first length of NM cable 30 is unequal to the second gauge of the at least one circuit conductor 46 of the second length of NM cable 40.

With continuing reference to FIG. 2, in a first embodiment of the present invention, the bottom surface 34 of the first length of NM cable 30 is coupled to the top surface 42 of the second length of NM cable 40 using a cementitious material 50. In accordance with this embodiment, the cementitious material 50 is applied to either the bottom surface 34 of the first length of NM cable 30 or to the top surface 42 of the second length of NM cable 40. The bottom surface 34 of the first length of NM cable 30 and the top surface 42 of the second length of NM cable 40 are then pressed together to form the coupled building wire 20. It will be appreciated that the cementitious material 50 may be any suitable cement-like substance such as PVC cement or the like.

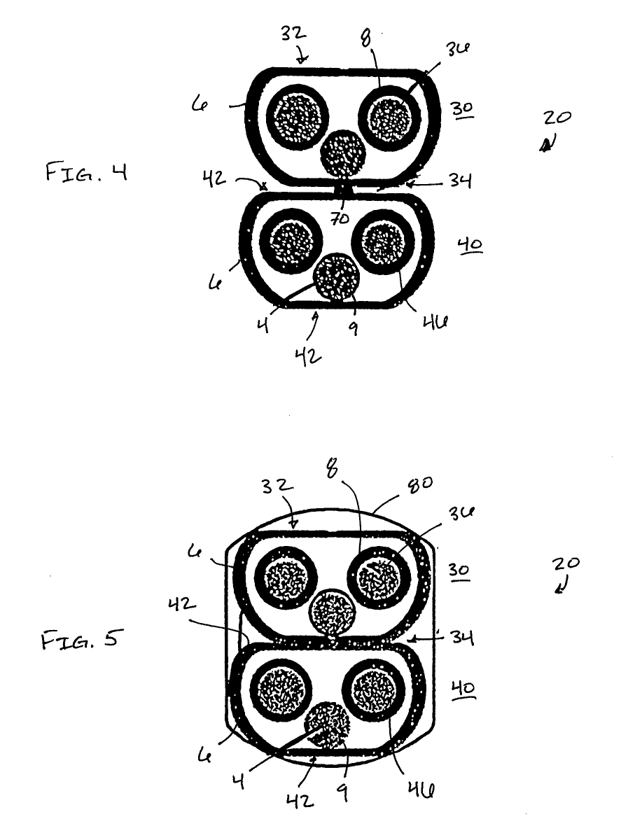

With reference to FIG. 3, in a second embodiment of the present invention, the bottom surface 34 of the first length of NM cable 30 is coupled to the top surface 42 of the second length of NM cable 40 using glue 60. In accordance with this embodiment, the glue 60 is applied to either the bottom surface 34 of the first length of NM cable 30 or to the top surface 42 of the second length of NM cable 40 as a non-continuous bead or as a continuous bead. The bottom surface 34 of the first length of NM cable 30 and the top surface 42 of the second length of NM cable 40 are then pressed together to form the coupled building wire 20. It will be appreciated that the glue 60 may be a soft glue or a hard glue.

With reference to FIG. 4, in a third embodiment of the present invention, the bottom surface 34 of the first length of NM cable 30 is coupled to the top surface 42 of the second length of NM cable 40 using a webbing material 70. In accordance with this embodiment, an extrusion machine is employed to apply the webbing material 70 to the bottom surface 34 of the first length of NM cable 30 and the top surface 42 of the second length of NM cable 40. The bottom surface 34 of the first length of NM cable 30 and the top surface 42 of the second length of NM cable 40 are then pressed together to form the coupled building wire 20. It will be appreciated that the webbing material 60 may be any suitable substance such as polypropylene webbing or the like.

With reference to FIG. 5, in a fourth embodiment of the present invention, the bottom surface 34 of the first length of NM cable 30 is coupled to the top surface 42 of the second length of NM cable 40 using heat shrinkable insulation 80. In accordance with this embodiment, the first length of NM cable 30 and the second length of NM cable 40 are wrapped together using a material constructed of PVC or polyolefin that, when subjected to an elevated temperature, draws in tightly around the cables 30 and 40. The heat shrinkable insulation 80 may be transparent for allowing visibility of the cables 30 and 40 and the circuit conductors 36 and 46, thereby providing electricians with the ability to distinguish such elements based on color. In still another embodiment, the first length of NM cable 30 and the second length of NM cable 40 are held together using a overall jacket, or tube.

In another embodiment of the present invention, the bottom surface 34 of the first length of NM cable 30 is coupled to the top surface 42 of the second length of NM cable 40 using at least two complementary strips of Velcro®-like material 90, i.e., material having complementary parts which adhere to each other when pressed together and adapted for use as a fastener. In accordance with this embodiment, at least one strip of Velcro®-like material is placed along the bottom surface 34 of the first length of NM cable and at least one complementary strip of Velcro®-like material is placed along the top surface of the second length of NM cable. The bottom surface 34 of the first length of NM cable 30 and the top surface 42 of the second length of NM cable 40 are then pressed together to adhere the complementary parts of the Velcro®-like material to each other to form the coupled building wire 20.

In a further embodiment of the present invention, the bottom surface 34 of the first length of NM cable 30 is coupled to the top surface 42 of the second length of NM cable 40 using a self-locking threaded fastener. In accordance with this embodiment, a self-locking threaded fastener, such as that commonly known by the trademark ZIPLOC, is attached to the bottom surface 34 of the first length of NM cable 30 and to the top surface 42 of the second length of NM cable 40. The bottom surface 34 of the first length of NM cable 30 and the top surface 42 of the second length of NM cable 40 are then pressed together to lock the self-locking fastener and form the coupled building wire 20. It will be appreciated that the self-locking fastener could be attached during assembly of the coupled building wire 20 or formed into the outer sheath 6 of the first 30 and second 40 lengths of cable by incorporating the self-locking fastener into extrusion tooling.

In still further embodiments of the present invention, the bottom surface 34 of the first length of NM cable 30 is coupled to the top surface 42 of the second length of NM cable 40 using any other suitable adhesive material or other means, such as double-sided tape, an adhesive polymeric strip, a binding strip (constructed of mylar, polyester, string or the like), welding (such as hot air welding, ultrasonic welding, solvent bonding or the like), or any combination of the above.

It will be appreciated that each of the aforementioned embodiments allow for easy separation of the first length of NM cable 30 from the second length of NM cable 40 once the coupled building wire has been pulled into the building or home that is under construction. Further, the preferred bonded embodiments offer an inherent tangle-resistance feature thereby reducing and possibly eliminating the problems of multiple cables tangling up during installation. Because the tangling of NM cable is a result of the wire conductors' “radii memory,” i.e., the tendency to remain coiled and resist straightening, the present invention eliminates any competing radii memory by providing more than one circuit in the same package and stored with the same radius.

Testing

In order to test whether the coupled building wire 20 of the present invention provides an advantage over conventional single building wire constructions, electricians were asked to pull test cables into an eight (8) foot by sixteen (16) foot mock building using an electrical wiring diagram. To establish a baseline, electricians pulled circuits having a single length of NM cable into the mock building according to the diagram and the time to complete the tasks was recorded. Then, electricians pulled various embodiments of the coupled building wire 20 into the mock building according to the same diagram and the time to complete the tasks were recorded. As demonstrated by Tables 1-8 below, the use of the coupled building wire 20 of the present invention consistently reduced the time to install the test wiring.

Having thus described the invention in detail, it should be apparent that various modifications and changes may be made without departing from the spirit and scope of the present invention. Consequently, these and other modifications are contemplated to be within the spirit and scope of the following claims.

I claim:

1. A coupled building wire comprising:
a first length of non-metallic sheathed cable having a top surface and a bottom surface;
a second length non-metallic sheathed cable having a top surface and a bottom surface;
wherein the bottom surface of the first length of non-metallic cable is coupled to the top surface of the second length of non-metallic cable, wherein the first length of non-metallic cable comprises one circuit conductor having a first gauge and the second length of non-metallic cable comprises one circuit conductor having a second gauge, and wherein the first gauge of the first length of non-metallic cable is substantially equal to the second gauge of the second length of non-metallic cable.

2. A coupled building wire comprising:
a first length of non-metallic sheathed cable having a top surface and a bottom surface;
a second length non-metallic sheathed cable having a top surface and a bottom surface;
wherein the bottom surface of the first length of non-metallic cable is coupled to the top surface of the second length of non-metallic cable, wherein the first length of non-metallic cable comprises one circuit conductor having a first gauge and the second length of non-metallic cable comprises one circuit conductor having a second gauge, and wherein the first gauge of the circuit conductor of the first length of non-metallic cable is unequal to the second gauge of the circuit conductor of the second length of non-metallic cable.

3. A coupled building wire as defined in claim 1 wherein the bottom surface of the first length of non-metallic cable is coupled to the top surface of the second length of non-metallic cable by materials selected from the group consisting essentially of cementations material, glue, webbing material, heat-shrinkable material, material having complimentary parts which adhere to each other when pressed together, self-locking threaded fasteners, adhesive material, double-sided tape, adhesive polymeric strip, binding strip, welding, and combinations thereof.

4. A coupled building wire as defined in claim 3 wherein the binding strip is constructed of mylar, polyester, string, and combinations thereof.

5. A coupled building wire as defined in claim 1 wherein the bottom surface of the first length of cable is coupled to the top surface of the second length of cable by hot-air welding, ultrasonic welding, solvent welding, or combinations thereof.

6. A coupled building wire as defined in claim 2 wherein the bottom surface of the first length of cable is coupled to the top surface of the second length of cable by hot-air welding, ultrasonic welding, solvent welding, or combinations thereof.
